(19) United States
(12) Patent Application Publication
(10) Pub. No.: US 2011/0143109 A1
(43) Pub. Date: Jun. 16, 2011

(54) HIGH VISIBILITY SAFETY ORANGE WITH REDUCED VISIBILITY TO DEER AND OTHER DICHROMATIC ANIMALS

(76) Inventors: Kurt von Besser, Orangeburg, SC (US); Daniel Gutting, Ornngebury, SC (US)

(21) Appl. No.: 12/634,720

(22) Filed: Dec. 10, 2009

(51) Int. Cl. B32B 7/02; F21V 9/06

(52) U.S. Cl. 428/212; 252/588

(57) ABSTRACT

The present invention relates to a material with high visibility to humans and low visibility to deer and other dichromatic animals, and a method for making the same. The color “Safety Orange” emits and reflects light at the long visible wavelengths of 595-605 nm, which are conspicuous to humans and largely unseen by dichromates. Common manufacturing and laundering practices cause existing Safety Orange products to also emit strongly at 455 nm and 496 nm, the peak sensitivity of deer blue cones and deer rods respectively. The present invention differentially reduces light emission and reflection at wavelengths below 500 nm for decreased visibility to dichromatic animals. This differential reduction preferably incorporates a pattern, such as a camouflage pattern, to further reduce visibility to deer. This pattern is preferably visible to dichromates while remaining largely invisible to humans.

This application claims priority from U.S. Provisional Patent Application Ser. No. 61/121,922 entitled HIGH VISIBILITY SAFETY ORANGE WITH REDUCED VISIBILITY TO DEER AND OTHER DICHROMATIC ANIMALS, filed Dec. 12, 2008, hereby incorporated by reference.

### BACKGROUND OF THE INVENTION

(a) Field of the Invention

The present invention relates to a material with high visibility to humans and low visibility to deer and other dichromatic animals, and a method for making the same. The color “Safety Orange” emits and reflects light at the long visible wavelengths of 595-605 nm, which are conspicuous to humans and largely unseen by dichromates. Common manufacturing and laundering practices cause existing Safety Orange products to also emit strongly below 500 nm. The blue cones and rods of the deer are highly sensitive to this light, peaking at 455 nm and 496 nm, respectively. The cornea of deer does not filter out short wavelength light as is done by the human eye. This gives deer enhanced night vision at the expense of UV protection. The present invention differentially reduces light emission and reflection at wavelengths below 500 nm for decreased visibility to dichromatic animals. This differential reduction preferably incorporates a pattern, such as a camouflage pattern, to further reduce visibility to deer. This pattern is preferably visible to dichromates while remaining largely invisible to humans.

(b) Description of the Prior Art

An excellent description of the nature of vision and the differences between trichromatic human vision and the dichromatic vision of deer and other ungulates may be found in the specification of Neitz et al., U.S. Pat. No. 5,409,760 (“Neitz”), incorporated herein by reference.

Traditional camouflage uses a mixture of browns and greens to simulate the forest background against which human would be perceived by an animal. Such camouflage may make a hunter inconspicuous to an animal, but also makes the hunter inconspicuous to other hunters. This presents a dangerous situation where a camouflaged hunter may be mistaken for a target animal by another hunter.

The incidence of hunting accidents from use of traditional camouflage has led many states to require hunters to wear clothing comprising a vivid orange color referred to as “Safety Orange,” “Hunter's Orange,” or “Blaze Orange.” Approved Safety Orange fabric must emit at least 85% of its luminance in a narrow band of wavelengths between 595-605 nm and have at least a 40% luminosity factor. The colorants commonly used in Safety Orange garments reflect strongly near the peak of human visual sensitivity, and thus make the wearer of a Safety Orange garment conspicuous to humans. Due to the differences between trichromatic human vision and dichromatic ungulate vision, as explained in Neitz, Safety Orange, as a color of 595-605 nm, is not conspicuous to deer.

Ultraviolet (“UV”) brighteners, also called bluing, brightening dye, color safe bleach, optical brightener, fluorescent whitening agents, or laundry enhancers, are UV dyes used to collect energy from a wide range of UV and short blue wavelengths and reradiate that energy in a powerful peak at about 440 nm. While 440 nm light is almost invisible to humans, it is near the maximum sensitivity of ungulates. In particular, the peak sensitivities of deer blue cones and rods are at 455 nm and 496 nm, respectively. Many fabrics, especially poly/cotton blends, are often impregnated with UV brighteners when manufactured. Most laundry detergents also contain UV brighteners. Over 200 types of UV brighteners exist and most provide a permanent effect on treated fabric.

While the color Safety Orange itself is not particularly conspicuous to deer, the standard manufacturing and laundering technique of using UV brighteners makes Safety Orange fabric very prominent to deer. Dichromatic animals like deer perceive only two colors, yellow and blue, with degrees of colorlessness between them. Forest colors, such as greens, browns, and tans, appear to deer as grays with varying shades of yellow. Safety Orange would also be perceived as a yellow color. However, the short wavelength light reradiated by UV brighteners is perceived as a bright blue and is very distinctive in a deer's largely yellow and gray environment. At night and in low light situations, humans and deer lack color vision and the world is perceived primarily as shades of gray. In such situations, the short wavelength light reradiated by UV brighteners is perceived by deer as a conspicuous bright white color. Products such as U-V-Killer®, provided by Atsko, Inc., of Orangeburg, S.C., can reduce the effect of UV brighteners, decreasing the conspicuousness of Safety Orange fabric to deer.

Many states require that hunters wear garments displaying a solid orange color. In Kentucky, for example, regulations require that a hunter and any person accompanying a hunter display solid, unbroken Hunter Orange visible from all sides on the head, back, and chest. Garments with a human-visible variegated appearance, such as an orange/black camouflage pattern, are not allowed.

Neitz discloses a method of decreasing detection by deer by taking advantage of the neutral point of dichromatic vision. The prior art discloses a camouflage material including two segments, where photopic light emissions from the two segments induce the same perception of color in a deer as a monochromatic light at 480+/−25 nm. Dichromatic deer vision only perceives two colors, yellow and blue. Light with a wavelength of 480 nm equally stimulates a deer's yellow and blue cones and is perceived as a colorless white or shade of gray, depending on its intensity and background illumination. However, this method provides a solid, unbroken block consisting of a single color or shade of gray. Solid blocks of color are unlikely to be found in nature and thus appear distinct from the background environment. A need exists for a material or method of treating a material to have a solid, unbroken, high visibility appearance to human vision and a variegated, low visibility appearance to deer vision.

### SUMMARY OF THE INVENTION

The aforementioned problems have been solved in the present invention. The present invention comprises material, preferably a fabric, with high visibility, uniform appearance to humans and a variegated, low visibility appearance to deer. The present invention also comprises a method of reducing visibility to dichromates, particularly deer, by differential application of UV agents and/or colorants.

Differential application of UV agents or colorants to a material can create a material of variegated appearance to dichromatic ungulates, specifically deer. Materials with significant luminance at short wavelengths are treated by differentially applying UV agents and/or colorants to differentially reduce short wavelength emissions. Materials with no significant luminance at short wavelengths are treated by differentially applying UV brighteners and/or colorants to differentially increase short wavelength emissions. A material of variegated color or color intensity is more similar to a naturally occurring object than a material consisting of a solid block of color. Such a material may act as camouflage to dichromatic ungulate vision while still appearing as a solid block of high visibility color for human vision. Widespread adoption of the invention would improve acceptance of high visibility orange garments, increasing their use and hunter safety.

In one embodiment, the present invention is a method of reducing visibility of a material to dichromates, the method comprising differentially applying at least one UV agent to the material, whereby at least one UV agent modifies the light absorbing, reflecting, reemitting or reradiating properties of the material for wavelengths of less than about 500 nm, whereby the material is perceived by dichromates as an object of variegated color intensity or luminosity.

In another embodiment, the present invention is a camouflage material comprising a first section from which light emissions below 500 nm occur predominantly within a first band of wavelengths, a second section from which light emissions below 500 nm occur predominantly within a second band of wavelengths, and wherein the first section and second section are perceived as distinct levels of luminosity by deer. Preferably, a human observer would be unable to visually distinguish between the first and second sections using a standard test, such as the Two-Alternative Forced Choice test at a distance of 50 meters, 10 meters, 2 meters, or at any distance.

### GLOSSARY OF TERMS

As used herein, the following terms have the meanings indicated.

A “long wavelength” or “long wavelength color” refers to electromagnetic waves in the visible spectrum with wavelengths of about 570 nm or higher. Examples of long wavelength colors are the colors red, orange, and most yellows. “Short wavelength” or “short wavelength color” refers to electromagnetic waves in the visible or UV spectrum with wavelengths of about 500 nm or lower. Examples of short wavelength colors include near UV, violet, indigo, and most blues.

An “ultraviolet agent” or “UV agent” refers to an agent capable of modifying the short wavelength absorbing, reflecting, reemitting or reradiating properties of a material. An example UV agent capable of reducing the short wavelength luminance of a material is the product U-V-Killer®, provided by Atsko, Inc. An example of a UV agent capable of increasing the short wavelength luminance of a material is a UV brightener.

A “colorant” refers to an agent capable of modifying the color of a material as seen by an observer, where the observer may have trichromatic or dichromatic vision. Using this definition, a colorant capable of modifying the shortwave length absorbing, reflecting, re-emitting or re-radiating properties of a material is also a UV agent.

The terms “dichromatic” or “dichromatic vision” refer to color vision based on two populations of photopigments, such as the color vision possessed by deer. The terms “trichromatic” or “trichromatic vision” refer to color vision based on three populations of photopigments, such as the color vision possessed by humans.

The term “camouflage” refers to a pattern of two or more colors, or two or more hues, shades, levels of luminosity, or variations of the same color, used on an object which deceive the eye of an observer and promote concealment by encouraging the eye of the observer to follow the pattern rather than the outline of the underlying object, and thus hinders visual recognition of the underlying object. The term camouflage, as used herein, includes two or more colors, or hues, shades, levels of luminosity, or variations of the same color which are perceived as distinct colors or levels of luminosity by deer and differs from the “neutral point camouflage” disclosed in Neitz, which is perceived as a monochromatic color by deer and does not include a pattern visible to deer.

### DETAILED DESCRIPTION OF THE PREFERRED EMBODIMENT

The present invention uses differential application of UV agents and/or colorants to reduce visibility or conspicuousness of materials to dichromatic animals. It provides low visibility camouflage for the visual capabilities of deer without loss of solid high visibility for human vision for hunter protection.

A material which emits at least 5%, at least 10%, or at least 15% of total luminance at light wavelengths of less than about 500 nm may have its visibility decreased by application of the present invention. The present invention comprises a differential reduction of short wavelength emissions from a material, as opposed to a uniform blocking of the same. A differential reduction of short wavelength emissions, through the application of various concentrations or amounts of UV absorbing, reflecting, reemitting or reradiating agents, will reduce visibility of the material to dichromates. Subtle differential reduction of short wavelength emissions over various sections of a safety garment will cause it to be perceived by dichromates as an object of variegated color or color intensity (even if in similar hues), more like naturally occurring objects. In a preferred embodiment, this differential reduction of short wavelength emissions is applied to a material of high visibility to human vision, such as a Safety Orange fabric or a Safety Orange garment. In this embodiment, dichromates would view the garment as camouflage while humans would view the garment as a solid block of orange color. In an alternate embodiment, the camouflage pattern may be visible to both humans and dichromates.

The differential reduction of short wavelength emissions of the present invention can be applied either uniformly or by any variation, including but not limited to patterns of any type, repeating or random, by any application methods to achieve 1, 2, or more levels of reduction of visibility to dichromates in selected areas of the garment to increase effective camouflage by creating various levels of luminosity.

One embodiment of the present invention includes applying a first UV agent to a first section of a material, such that dichromates perceive two distinct shades, hues, or levels of luminosity, namely the first section of the material treated by the UV agent and a second section comprising the portion of the material untreated by the UV agent.

Another embodiment of the present invention includes applying a UV agent to a first section of a material in a first amount and to a second section of the material in a second amount. By using different first and second amounts of the UV agent, the short wavelength emissions of the first and second sections will differ. If the first and second sections cover the entire material, dichromates would perceive two distinct levels of luminosity or brightness, even if in similar hues of a color. If the first and second sections do not cover the entire material, dichromates would perceive three distinct levels of luminosity, namely the first section, the second section, and a third section comprising the untreated area of the material.

A further embodiment of the present invention includes applying a first UV agent to a first section of a material in a first amount and a second UV agent to a second section of a material in a second amount. The present embodiment contemplates first, second, third, and additional sections of a material, and applying first, second, third, and additional UV agents to those sections in first, second, third, and additional amounts.

A first section of a material may be a contiguous area or may be a plurality of blotches, stripes, or shapes. A first section of a material may be a plurality of first sections, whereby each blotch or stripe of a camouflage pattern is a separate first section. Second, third, and additional sections may also be contiguous areas or may be a plurality of areas.

### Example 1

This example demonstrates the preparation of an embodiment of the present invention including a camouflage pattern with two levels of luminosity visible to deer and an unchanged appearance to humans.

Select a first section of a garment, the first section comprising a plurality of blotches covering about half the surface area of the garment. Apply a sufficient amount of U-V-Killer® to the first section of the garment to provide about a 50% reduction in short wavelength emission. Apply an increased amount of U-V-Killer® to the remaining surface of the garment to provide about a 75% reduction in short wavelength emission.

### Example 2

This example demonstrates the preparation of an embodiment of the present invention including a camouflage pattern with three levels of luminosity visible to deer and an unchanged appearance to humans.

Select a first section and a second section of a Safety Orange vest, each section comprising a plurality of stripes covering about one third the surface area of the vest. Apply a sufficient amount of U-V-Killer® to the first section of the garment to provide about a 50% reduction in short wavelength emission. Apply an increased amount of U-V-Killer® to the second section of the garment to provide about a 75% reduction in short wavelength emission. Apply an even greater amount of U-V-Killer® to the remaining surface of the garment to provide about a 88% reduction in short wavelength emission.

Example 1 and Example 2 disclose application of a sufficient amount of UV agent to reduce the short wavelength emission of a section to about half the emission of untreated material or about half the emission of a previously treated section. In other embodiments, sufficient amount of UV agent may be applied to reduce the short wavelength emission of a section to any suitable fraction of the emission of untreated material or of a previously treated section, such that each section is visually distinct to deer.

In one embodiment, ordinary colorants not normally chosen for their effect on UV luminance may be applied to a material in various amounts and concentrations. By their opacity, these colorants may reduce reflection or re-emission of wavelengths below 500 nm. In effect, these colorants block at least a portion of UV and short blue wavelength light from reaching the UV brighteners, thus attenuating the 440 nm wavelength light reradiated by the UV brighteners and providing at least one level of reduction of visibility to dichromates. Based on the specific colorants used, the appearance of the material may or may not be changed to a human observer. The visibility of any change in appearance to a human observer may be dependent upon distance or lighting conditions. In a simple example, a Safety Orange garment which includes significant luminance at short wavelengths may be covered with varying amounts of an opaque Safety Orange colorant without significant short wavelength luminance, such that the appearance of the garment remains substantially unchanged to a human observer but a deer observer would perceive a differential reduction of visibility.

While primarily intended to reduce visibility of Safety Orange to dichromates, the present invention also applies to hot pink, intense red, fluorescent lime, chartreuse and other long wavelength colors that may be used in situations which require high visibility for humans and low visibility for dichromates.

Existing colorants for long wavelength colors of high luminance also have significant luminance at short wavelengths. More specifically, existing dyes, pigments, and other colorants that emit 80%, 85%, or 90% of luminance at a long wavelength color all have significant emission below 500 nm. Significant luminance at short wavelengths is emission of greater than 3%, greater than 5%, greater than 10%, or greater than 15% of total luminance at wavelengths below about 500 nm. The present invention may be used in connection with new colorants, not yet discovered, of long wavelength colors of high luminance that lack significant luminance below 500 nm. Such colorants could be applied to an existing material, such as a Safety Orange garment, to reduce its short wavelength luminance. The amount of such colorant used would depend upon the opacity of the colorant, in that a more opaque colorant would more efficiently reduce the short wavelength luminosity of the underlying material than a more transparent colorant. The new colorant could be applied to the entirety of a material with significant short wavelength luminosity or to distinct sections of the material. The new colorant could be applied at a uniform amount or concentration or could be applied in different amounts or concentrations to different sections of the material.

The present invention contemplates the availability of coloring methods for making long wavelength color without significant luminance below 500 nm. Such coloring methods may provide a material with less than about 3%, less than about 2% or less than about 1% of total luminance emitted at short wavelengths. Although a material made with such coloring methods would not be perceived as bright white by deer in low light conditions, it would still be viewed as an unnatural, solid block consisting of a black color. The present invention may reduce the conspicuousness of such a colorant using differential application of UV brighteners and/or short wavelength colorants. More specifically, one or more sections of a material produced using these coloring methods may be subtly brightened to provide a variegated appearance to deer, which would blend into the environment better than pure black. For example, a pattern of transparent UV brighteners may be applied to a Safety Orange garment, such that a variegated pattern is visible to deer while the garment appears solid Safety Orange to a human observer.

Although primarily intended for use in creating camouflage patterns visible to deer, the differential application of UV agents and/or colorants of the present invention may be used for other purposes. In particular, differential application of UV agents and/or colorants may be used to create words, logos, designs, trademarks, or other elements which may be used for advertising or marketing purposes. These marketing elements would be visible to humans under UV illumination, such as when exposed to a black light, and may or may not be visible to unaided human vision under various ambient lighting conditions. These marketing elements may be incorporated into camouflage patterns visible to deer, used in addition to camouflage patterns visible to deer, or used absent any camouflage patterns visible to deer.

In one embodiment, a Safety Orange hunter garment may include a differential application of UV agents which creates a marketing element, such as the trademark of the garment manufacturer, which is not visible to humans under ambient light. A store selling hunter garments may provide a source of UV illumination, such as a black light, which allows prospective purchasers to examine the luminosity of a garment as seen by deer. Upon inspection of the garment in this embodiment under UV illumination, a prospective purchaser would perceive the garment manufacturer's trademark.

The foregoing detailed description is given primarily for clearness of understanding and no unnecessary limitations are to be understood therefrom, for modifications can be made by those skilled in the art upon reading this disclosure and may be made without departing from the spirit of the invention and scope of the appended claims.

What is claimed is:

1. A method of reducing visibility of a material to dichromates, comprising differentially applying at least one UV agent to the material, whereby the at least one UV agent modifies the light absorbing, reflecting, reemitting or reradiating properties of the material for wavelengths of less than about 500 nm, whereby the material is perceived by dichromates as an object of variegated color intensity or luminosity.

2. The method of claim 1, wherein the step of differentially applying at least one UV agent to the material comprises applying a first amount of a first UV agent to a first section of the material.

3. The method of claim 2, wherein the step of differentially applying at least one UV agent further comprises applying a second amount of a second UV agent to a second section of the material.

4. The method of claim 3, wherein the first UV agent and the second UV agent are the same UV agent.

5. The method of claim 2, wherein the material emits at least 5% of total luminance at light wavelengths of less than about 500 nm prior to application of the first UV agent, and wherein the first UV agent reduces the luminosity of the material at light wavelengths of less than about 500 nm.

6. The method of claim 2, wherein the material emits at least 10% of total luminance at light wavelengths of less than about 500 nm prior to application of the first UV agent, and wherein the first UV agent reduces the luminosity of the material at light wavelengths of less than about 500 nm.

7. The method of claim 2, wherein the material emits at least 15% of total luminance at light wavelengths of less than about 500 nm prior to application of the first UV agent, and wherein the first UV agent reduces the luminosity of the material at light wavelengths of less than about 500 nm.

8. The method of claim 2, wherein the material emits less than about 3% of total luminance at light wavelengths of less than about 500 nm prior to application of the first UV agent, and wherein the first UV agent increases the luminosity of the material at light wavelengths of less than about 500 nm.

9. The method of claim 2, wherein the material emits less than about 1% of total luminance at light wavelengths of less than about 500 nm prior to application of the first UV agent, and wherein the first UV agent increases the luminosity of the material at light wavelengths of less than about 500 nm.

10. The method of claim 1, wherein the material is perceived by humans as a single color.

11. The method of claim 10, wherein the color is orange.

12. A camouflage material comprising:
a first section from which light emissions below 500 nm occur predominantly within a first band of wavelengths;
a second section from which light emissions below 500 nm occur predominantly within a second band of wavelengths; and
wherein the first section and second section are perceived as distinct levels of luminosity by deer.

13. The camouflage material of claim 12, wherein a normal human observer cannot visually distinguish between the first section and second section from a distance of 10 meters in a Two-Alternative Forced Choice Test.

14. The camouflage material of claim 13, wherein a normal human observer cannot visually distinguish between the first section and second section from a distance of 2 meters in a Two-Alternative Forced Choice Test.

15. The camouflage material of claim 12, further comprising a plurality of first sections and a plurality of second sections.

16. The camouflage material of claim 12, wherein the camouflage material is perceived as orange by a normal human observer.

17. The camouflage material of claim 12, wherein the camouflage material is a fabric.

18. The camouflage material of claim 12, wherein the camouflage material is a garment.

19. The camouflage material of claim 12, wherein the camouflage material is a hunting blind.

20. The camouflage material of claim 12, further comprising a third section from which light emissions below 500 nm occur predominantly within a third band of wavelengths, and wherein the first section, second section, and third section are perceived as distinct levels of luminosity by deer.

21. The camouflage material of claim 12, wherein the first section and second section are arranged to create the visual appearance of a marketing element visible to humans in the presence of UV illumination.
